(19) United States
(12) Patent Application Publication
(10) Pub. No.: US 2026/0134810 A1
(43) Pub. Date: May 14, 2026

(54) DISPLAY SETTING ADJUSTMENT

(71) Applicant: Roku, Inc., San Jose, CA (US)

(72) Inventor: Hsuan-Hao Hsu, Taoyuan City (TW)

(73) Assignee: Roku, Inc., San Jose, CA (US)

(21) Appl. No.: 18/946,519

(22) Filed: Nov. 13, 2024

(51) Int. Cl. G09G 3/20

(52) U.S. Cl. CPC G09G 3/2003; G09G 2320/064; G09G 2320/0666; G09G 2330/045

(57) ABSTRACT

Disclosed herein are system, apparatus, article of manufacture, method and/or computer program product embodiments, and/or combinations and sub-combinations thereof, for adjusting a display setting of a display device by receiving a display status value from a sensor and determining that a display value is outside a predetermined range. An example embodiment operates by receiving the display status value of the display device from the sensor, where the display status value is determined based on at least one of a brightness of the display device and a color value of the display device. The example embodiment further operates by determining that the display status value is outside a predetermined range. The example embodiment further operates by adjusting at least one of the brightness of the display device and the color value of the display device in response to the determination, thereby controlling the display setting of the display device.

### BACKGROUND

### FIELD

This disclosure is generally directed to adjusting a display setting, and more particularly to adjusting a display setting based on a display status value.

### SUMMARY

Provided herein are system, apparatus, article of manufacture, method and/or computer program product embodiments, and/or combinations and sub-combinations thereof, for adjusting a display setting based on a display status value.

An example embodiment operates by receiving the display status value of the display device from a sensor, where the display status value is determined based on at least one of a brightness of the display device and a color value of the display device. The example embodiment further operates by determining that the display status value is outside a predetermined range. The example embodiment further operates by adjusting at least one of the brightness of the display device and the color value of the display device in response to the determination, thereby controlling the display setting of the display device.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3A illustrates a front view of a display device, according to some embodiments.

FIG. 3B illustrates a partially enlarged cross-sectional view of the display device of FIG. 3A as viewed along line A-A′, according to some embodiments.

FIG. 4 is a flowchart for a method for display setting adjustment, according to some embodiments.

FIG. 5 is a flowchart for a method for an update data distribution, according to some embodiments.

FIG. 6 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for adjusting a display setting based on a display status value.

Embodiments described herein provide for adjusting a display setting by receiving the display status value from a sensor and determining that the display value is outside a predetermined range. This may allow the display device to adjust to display appropriate brightness and color autonomously even if the brightness or color of the display device has deteriorated. The deterioration may be caused by years of use, improper brightness (e.g., too bright) or color (e.g., too red) settings, or other factors. Because the deterioration of the display devices may progress slowly over time, users often do not notice it. However, as the deterioration progresses, the display device may show images with brightness or color that is different from what the content creator intended. Therefore, by selecting appropriate display settings before the deterioration progresses, the speed of deterioration can be reduced.

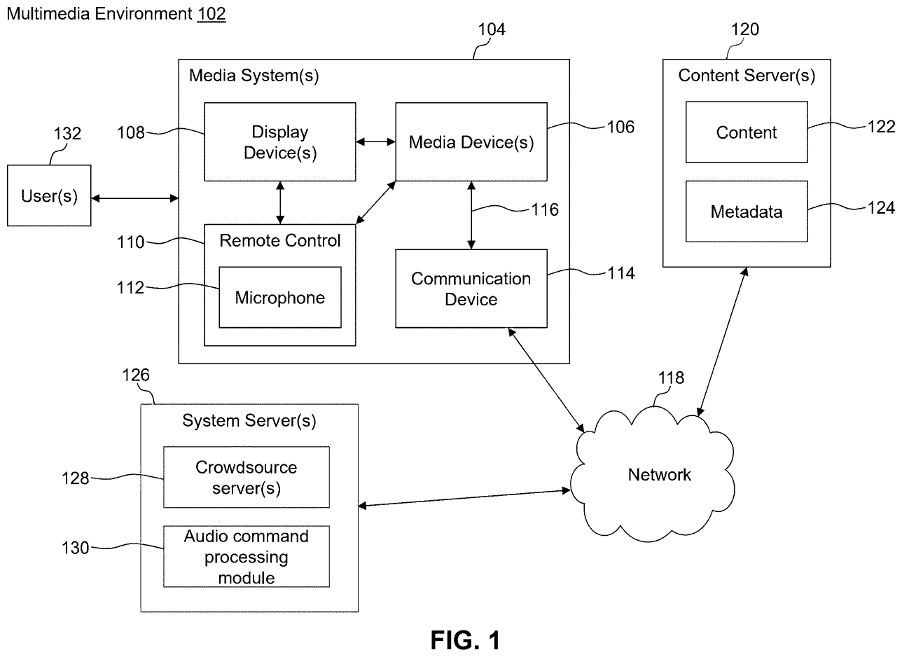

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some embodiments, media device 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as WiFi) and/or wired connections.

In various embodiments, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, laptop computer, smartphone, wearable, on-screen controls, integrated control buttons, audio controls, or any combination thereof, to name just a few examples. In an embodiment, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels or sources 120). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126.

The media devices 106 may exist in thousands or millions of media systems 104. Accordingly, the media devices 106 may lend themselves to crowdsourcing embodiments and, thus, the system servers 126 may include one or more crowdsource servers 128.

For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 128 may operate to cause closed captioning to be automatically turned on and/or off during future streamings of the movie.

The system servers 126 may also include an audio command processing module 130. As noted above, the remote control 110 may include a microphone 112. The microphone 112 may receive audio data from users 132 (as well as other sources, such as the display device 108). In some embodiments, the media device 106 may be audio responsive, and the audio data may represent verbal commands from the user 132 to control the media device 106 as well as other components in the media system 104, such as the display device 108.

In some embodiments, the audio data received by the microphone 112 in the remote control 110 is transferred to the media device 106, which is then forwarded to the audio command processing module 130 in the system servers 126. The audio command processing module 130 may operate to process and analyze the received audio data to recognize the user 132's verbal command. The audio command processing module 130 may then forward the verbal command back to the media device 106 for processing.

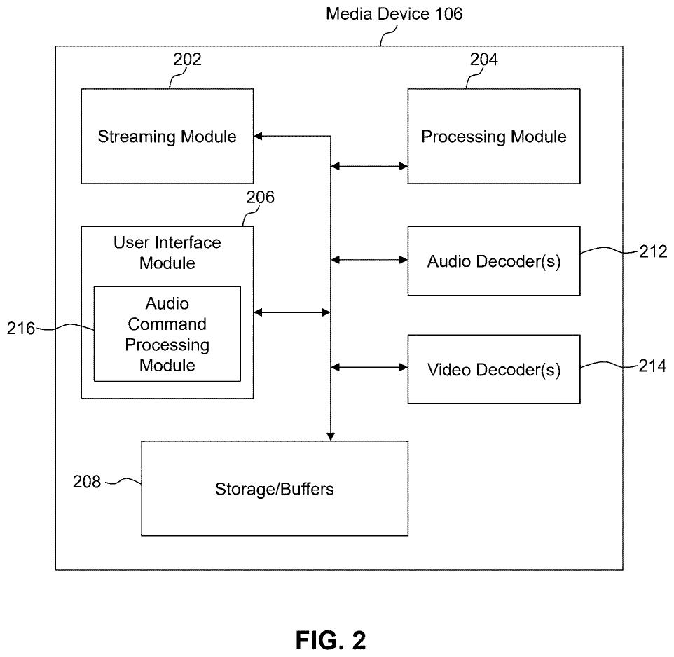

In some embodiments, the audio data may be alternatively or additionally processed and analyzed by an audio command processing module 216 in the media device 106 (see FIG. 2). The media device 106 and the system servers 126 may then cooperate to pick one of the verbal commands to process (either the verbal command recognized by the audio command processing module 130 in the system servers 126, or the verbal command recognized by the audio command processing module 216 in the media device 106).

FIG. 2 illustrates a block diagram of an example media device 106, according to some embodiments. Media device 106 may include a streaming module 202, processing module 204, storage/buffers 208, and user interface module 206. As described above, the user interface module 206 may include the audio command processing module 216.

The media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, AOMedia Video 1 (AV1 ), HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some embodiments, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming module 202 of the media device 106 may request the selected content from the content server(s) 120 over the network 118. The content server(s) 120 may transmit the requested content to the streaming module 202. The media device 106 may transmit the received content to the display device 108 for playback to the user 132.

In streaming embodiments, the streaming module 202 may transmit the content to the display device 108 in real time or near real time as it receives such content from the content server(s) 120. In non-streaming embodiments, the media device 106 may store the content received from content server(s) 120 in storage/buffers 208 for later playback on display device 108.

### Configuration of a Display Device to Adjust its Display Setting

Referring to FIG. 1, display device 108 may have a structure to adjust display appropriate brightness and/or color autonomously even if the brightness or color of the display device has deteriorated due to years of use, improper brightness (e.g., too bright) or color (e.g., too red) settings, or other factors. As explained above, because the deterioration of the display devices may progress slowly over time, users often do not notice it. However, as the deterioration progresses, the display device may show images with brightness or color that is different from what the content creator intended. Therefore, by selecting appropriate display settings before the deterioration progresses, the speed of deterioration can be reduced.

For example, using a display status value of display device 108 received from a sensor, display device 108 may determine the display status value is outside a predetermined range. Then, display device 108 may control a display setting of display device 108 to adjust at least one of a brightness of display device 108 and a color value of display device 108. Accordingly, display device 108 may adjust brightness and/or color autonomously even if the brightness or color of display device 108 has deteriorated. Display device 108 may suffer from various technical problems, including the technical problems of changing color or brightness due to the heat generated by internal components or aging. The above mentioned adjustment can solve these technical problems.

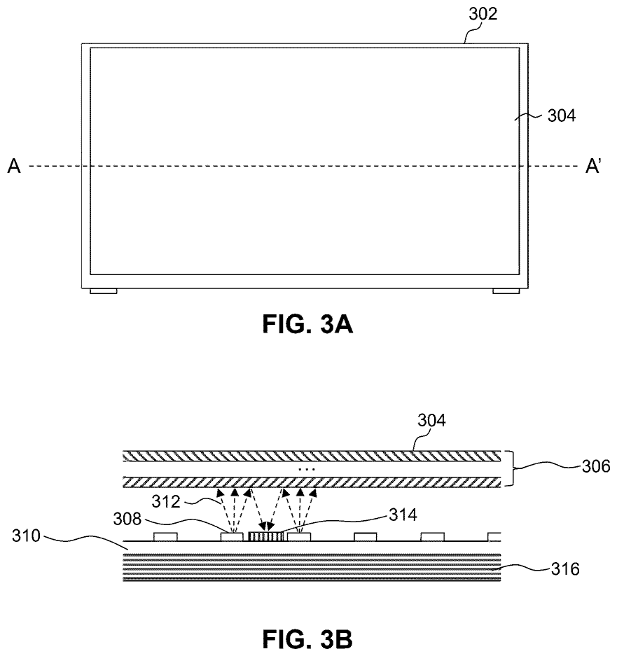

FIG. 3A illustrates a front view of a display device 302, according to some embodiments. The display device 302 may be one of the implementations of display device 108. The display device 302 may be a monitor, television (TV), computer, smart phone, tablet, wearable (such as a watch or glasses), appliance, and/or internet of things (IoT) device, to name just a few examples.

Display device 302 may include a display panel 304. A display panel 304 may display content from various sources (e.g., streaming content from system server 126). The display panel 304 may be a liquid crystal display (LCD), light-emitting diode (LED) display, organic light-emitting diode (OLED) display, or other electronic display as would be appreciated by a person of ordinary skill in the art.

FIG. 3B illustrates a partially enlarged cross-sectional view of the display device 302 of FIG. 3A as viewed along line A-A′, according to some embodiments. The upper side in FIG. 3B is the front side of the display device 302 and the lower side in FIG. 3B is the rear side of the display device 302.

Optical material(s) 306 may be a component of the display panel 304. The optical material(s) 306 may consist of open cells, optical films, and other components stacked in layers.

Light-emitting element(s) 308 may illuminate the display panel 304 from the rear side of the display panel 304. The light-emitting element(s) 308 may work as the light source for the display device 302. The light emitted from the emitting element(s) 308 is schematically shown as light 312.

Multiple light-emitting elements 308 may be arranged in the display panel 304. For example, in FIG. 3B, a plurality of light-emitting elements 308 are arranged on a base 310.

A sensor 314 may detect the brightness and/or color of incoming light 312. The sensor 314 may be a photodiode, a complementary metal-oxide semiconductor (CMOS) sensor, or any other optical sensor. As shown in FIG. 3B, the sensor 314 may be located in a space between the display panel 304 and the light-emitting elements 308. As shown in FIG. 3B, the sensor 314 and the light-emitting elements 308 may be located on a back plate 316 of the display device 302.

The detected brightness may be converted to one or more brightness values that can be processed by one or more processors of the display device 302. The detected colors may also be converted to one or more color coordinates that can be processed by the processor of the display device 302. The converted brightness value and the color coordinates may be referred to as a display status value. The predetermined range may be used to determine a thermal threshold value at which the display device 302 adjusts or does not adjust the display setting of the display device 302. For example, the display device 302 may control the display setting of the display device 302 to adjust the brightness and/or the color value, if the display status value is outside of the predetermined range.

The predetermined range may be a function of brightness and/or color value. For example, the predetermined value may be ±10% of a target value of the brightness and/or the color value (e.g., “±10% of 1000 nit and/or (0.6, 0.4) (of color coordinates)”). The predetermined value may be changed depending on a scene displayed on the display device 302. For example, predetermined ranges may be set for each of a predetermined test pattern, a startup screen, a menu screen, etc. An initial value of the predetermined range may be set at a factory.

The light-emitting elements 308 and the sensor 314 may be placed in different locations or in different positions with other components, depending on the type of display device 302. FIG. 3B illustrates an LCD display as an example of the display device 302 which uses LEDs as light-emitting elements 308. This disclosure is also applicable to the use of display panels 304 other than LCD display panel panels.

For example, the sensor 314 may be located at the edge of the display device 302. In this way, the sensor 314 may not block the light emitted from the light-emitting elements 308, where the display panel 304 is an OLED or LED display, or other type of a self-luminous display.

The sensor 314 may also be located outside of the display device 302. For example, the sensor 314 may be located in the media device 106, the remote control 110, or the communication device 114 or any additional devices. In such cases, the display device 302 may display a message to direct the device described above (e.g., media device 106, remote control 110, etc.) to the display panel 304 so that the brightness and or color of the display panel 304 is properly detected.

The display device 302 may detect data other than the brightness and/or the color of the display device 302. For example, the display device 302 may include a counter which counts a cumulative time period of use of the display device 302. The limits of the brightness and color adjustment range may change as the cumulative time period of use of the display device 302 becomes longer. To address this issue, the cumulative time period of use of the display device 320 may be used to adjust the predetermined range.

In another example, the display device 302 may include a temperature sensor that detects a temperature of the display device 302. If the temperature of the display device 302 is too high (e.g., above a thermal threshold value such as, but not limited to 140° F.), the display setting may not be able to be controlled. For example, even if the brightness of the display device 302 is below the predetermined range, the brightness may not be increased so as not to raise the temperature any further. To address this technical issue, the display device 302 may not control one or more display settings so as not to adjust the brightness of the display device 302 to be brighter than a current brightness of the display device 302.

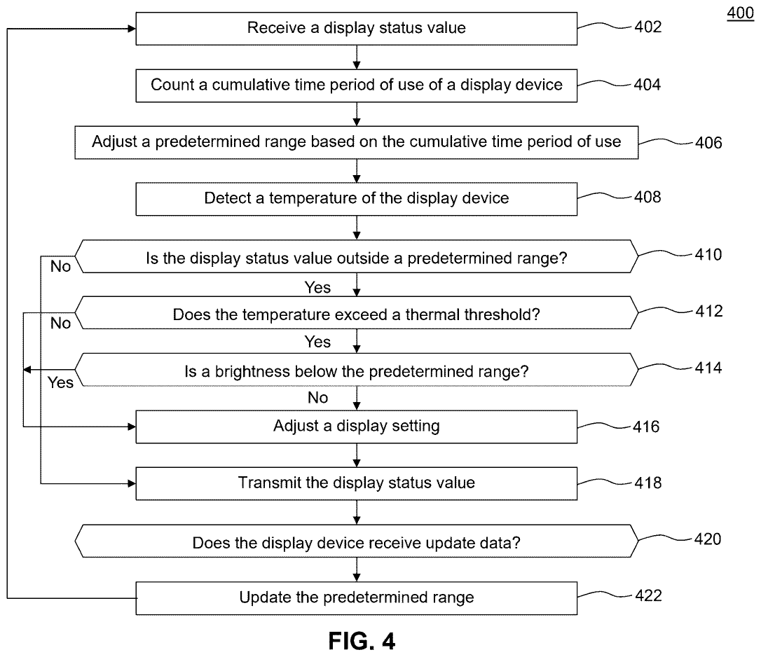

FIG. 4 is a flowchart for a method 400 for display setting adjustment, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIGS. 1 and 3. However, method 400 is not limited to those example embodiments.

In step 402, the display device 302 may receive a display status value. The display status may be determined based on at least one of a brightness of the display device and a color value of the display device. The brightness of the display device and/or the color value of the display device may be sensed by the sensor 314.

In step 404, the display device 302 may count the cumulative time period of use of a display device 302. The cumulative time period of use of a display device 302 may be determined based on a usage time of the display panel 304.

In step 406, the display device 302 may adjust a predetermined range based on the cumulative time period of use of the display device 302. For example, the display device 302 may lower the brightness used for the predetermined range if the use of the display device 302 exceeds 36 months. The display device 302 may also lower the brightness used for the predetermined range as the cumulative time period of use of the display device 302 increases (e.g., until a threshold value for the cumulative time period of use) .

In step 408, the display device 302 may detect the temperature of the display device 302. The temperature of the display device may be detected by the temperature sensor located near the display panel 304.

In step 410, the display device 302 may determine whether the display status value is outside the predetermined range.

In step 412, if the display status value is outside the predetermined range (“Yes” in step 410), the display device 302 may determine whether the temperature of the display device 302 exceeds a thermal threshold value (e.g., 140° F.).

In step 414, if the temperature of the display device 302 exceeds the thermal threshold (“Yes” in step 412), the display device 302 may determine whether the brightness of the display device is below the predetermined range. If the brightness is not below the predetermined range, the brightness may be decreased in step 416, which is described below. If the brightness is below the predetermined range, step 416 may be skipped. By making the decisions in steps 412 and 414 in this way, the display device 302 may prevent the brightness of the display device 302 from being increased from the current value if the temperature exceeds the thermal threshold value.

In step 416, the display device 302 may adjust the display setting. For example, the display device 302 may control the display setting to increase the brightness of the display device 302 if the detected brightness lowers the predetermined range. The control of the brightness may be performed by increasing or decreasing the brightness of the light-emitting elements 308. The display device 302 may also control the one or more display settings to adjust the color of the display device if the detected color value is outside the predetermined range. The control of the brightness may be performed by adjusting a parameter of the light-emitting elements 308 and/or the display panel 304. Once the display device 302 has completed the controlling of the one or more display settings, the display device 302 may provide a user (e.g., user 132) of the display device 302 with a notification to indicate that the display setting have been updated. Notifications made by the display device 302 may include text or icons displayed on the display device 302, or audio played from the display device 302 or other devices (e.g., media device 106, remote control 110, etc.).

In step 418, the display device 302 may transmit the display status value to a system server 126 over the network 118. The system server 126 may collect a large number of display status values from the display devices 302 installed at each location and perform data analysis. If the system server 126 determines that a change is needed to the predetermined range as a result of the data analysis, the system server 126 may distribute updated data to the display devices 302. The model number or type of the display device 302, the cumulative time period of use, the temperature, or any other various data that can be obtained from the display device 302 may also be transmitted to the system server 126 for data analysis.

In step 420, the display device 302 may determine whether the display device 302 received the updated data. The updated data may be distributed from a system server 126 over the network 118.

In step 422, if the display device 302 received the updated data, the display device 302 may update the predetermined range based on the received updated data. For example, the updated data may have the same data format as the specified range, and the display device 302 may overwrite the predetermined range with the received updated data.

In this way, the display device 302 may autonomously adjust the brightness and/or color even when the brightness and/or color of the display device 302 are different from the expected value due to the heat generated by the light-emitting elements 308, years of use, or other unexpected defects. The display device 302 can autonomously adjust the brightness and/or color.

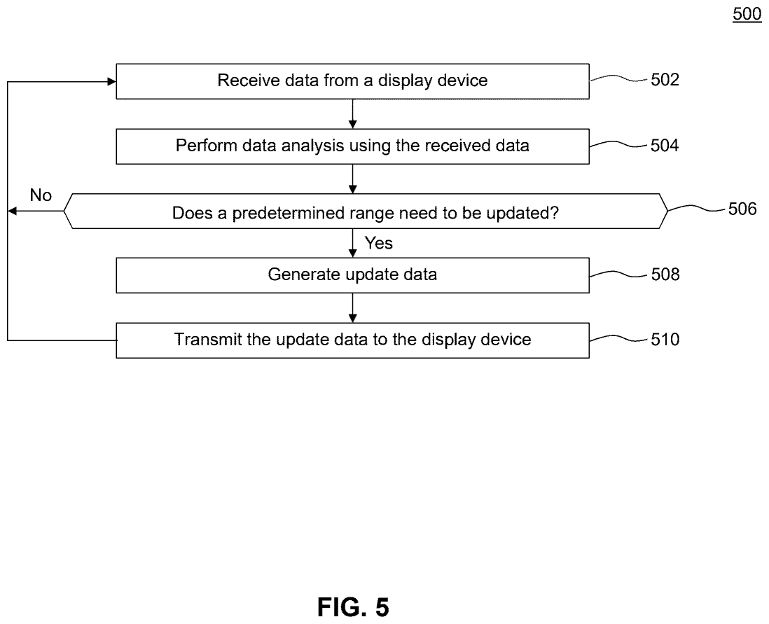

FIG. 5 is a flowchart for a method 500 for an update data distribution, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 500 shall be described with reference to FIGS. 1, 3, and 4. However, method 500 is not limited to those example embodiments. As explained in steps 418, 420, and 422 in FIG. 4, the display device 302 may transmit the display status value to a system server 126 over the network 118 and update the predetermined range based on the update data received from the system server 126. The operation of the system server 126 is explained in further detail below.

In step 502, the system server 126 may receive data from the display device 302 over the network 118. The data may include the display status value, the model number or type of the display device 302, the cumulative time period of use, the temperature, and/or any other various data that can be obtained from the display device 302. The system server 126 may receive data from multiple display devices 302.

In step 504, the system server 126 may perform data analysis using the received data from the display device 302. The data analysis may include multivariate analysis or artificial intelligence (AI) analysis based on the data received. For example, data analysis may include modeling of how the brightness or color of the display device 302 changes before the adjustment based on the model number or type of the display device 302, the cumulative time period of use, and/or the display setting of the display device 302.

In step 506, the system server 126 may determine whether the predetermined range needs to be updated. For example, if the results of data analysis show that the display device 302 of a particular model deteriorates significantly in brightness compared to other models after a particular usage time, and it is determined that the brightness cannot be set appropriately within the current predetermined range, the system server 126 may determine that it is necessary to update the predetermined range. If there is no need to update, the process may return to step 502.

In step 508, (“Yes” in step 506) the system server 126 may generate the update data for the display device 302. The update data may include the updated predetermined range.

In step 510, the system server 126 may transmit the update data to the display device 302. Thus, the system server 126 can update the predetermined range for appropriately adjusting the display setting based on the collected data even after the display device 302 has actually been started for use by the user.

### Example Computer System

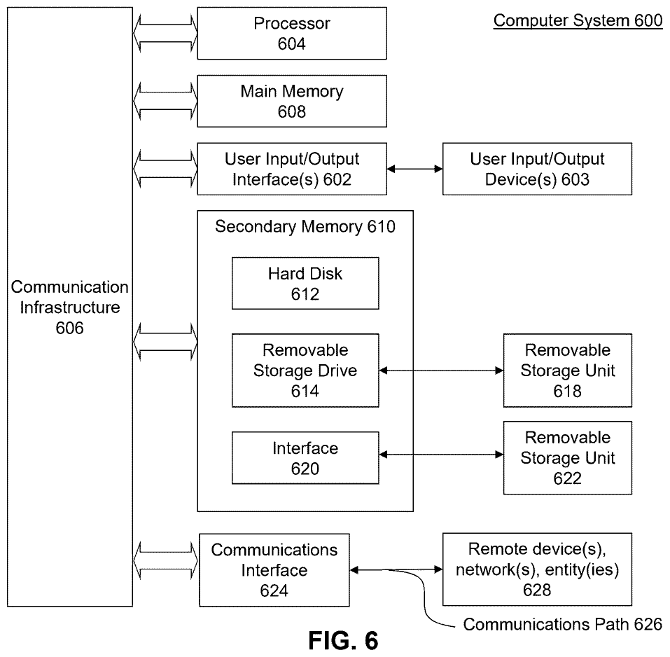

Various embodiments may be implemented, for example, using one or more well-known computer systems, such as computer system 600 shown in FIG. 6. For example, the media device 106 may be implemented using combinations or sub-combinations of computer system 600. Also or alternatively, one or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600 or processor(s) 604), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

### Conclusion

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A computer-implemented method for controlling a display setting of a display device, comprising:
receiving, by at least one computer processor, a display status value of the display device from a sensor, wherein the display status value is determined based on at least one of a brightness of the display device and a color value of the display device;
determining a cumulative time period of use of the display device, wherein the cumulative time period is based on a usage time;
determining that the display status value is outside a predetermined range, wherein the predetermined range is based on the cumulative time period; and
in response to the determination, adjusting at least one of the brightness of the display device and the color value of the display device, thereby controlling the display setting of the display device.

2. The computer-implemented method of claim 1, wherein the sensor is located in a space between a display panel of the display device and a light source illuminating the display panel.

3. The computer-implemented method of claim 2, wherein the light source and the sensor are located on a back plate of the display device.

4. The computer-implemented method of claim 1, further comprising:
adjusting the predetermined range based on the cumulative time period of use of the display device, wherein a brightness used for the predetermined range is decreased as the cumulative time period increases.

5. The computer-implemented method of claim 1, further comprising:
detecting that a temperature of the display device exceeds a thermal threshold value; and
in response to the detecting, skipping increasing the brightness of the display device.

6. The computer-implemented method of claim 1, further comprising:
transmitting the display status value over a network; and
updating the predetermined range based on data received over the network.

7. The computer-implemented method of claim 1, wherein the sensor is located outside of the display device.

8. A system, comprising:
one or more memories;
at least one processor each coupled to at least one of the memories and configured to perform operations comprising:
receiving a display status value of a display device from a sensor, wherein the display status value is determined based on at least one of a brightness of the display device and a color value of the display device;
determining a cumulative time period of use of the display device, wherein the cumulative time period is based on a usage time;
determining that the display status value is outside a predetermined range, wherein the predetermined range is based on the cumulative time period; and
in response to the determination, adjusting at least one of the brightness of the display device and the color value of the display device, thereby controlling the display setting of the display device.

9. The system of claim 8, wherein the sensor is located in a space between a display panel of the display device and a light source illuminating the display panel.

10. The system of claim 9, wherein the light source and the sensor are located on a back plate of the display device.

11. The system of claim 8, further comprising:
adjusting the predetermined range based on the cumulative time period of use of the display device, wherein a brightness used for the predetermined range is decreased as the cumulative time period increases.

12. The system of claim 8, further comprising:
detecting that a temperature of the display device exceeds a thermal threshold; and
determining not to adjust the brightness of the display device to be brighter than a current brightness of the display device.

13. The system of claim 8, further comprising:
transmitting the display status value over a network; and
updating the predetermined range based on data received over the network.

14. The system of claim 8, wherein the sensor is located outside of the display device.

15. A non-transitory computer-readable medium having instructions stored thereon that, when executed by at least one computing device, cause the at least one computing device to perform operations comprising:
receiving a display status value of a display device from a sensor, wherein the display status value is determined based on at least one of a brightness of the display device and a color value of the display device;
determining a cumulative time period of use of the display device, wherein the cumulative time period is based on a usage time;
determining that the display status value is outside a predetermined range, wherein the predetermined range is based on the cumulative time period; and
in response to the determination, adjusting at least one of the brightness of the display device and the color value of the display device, thereby controlling the display setting of the display device.

16. The non-transitory computer-readable medium of claim 15, wherein the sensor is located in a space between a display panel of the display device and a light source illuminating the display panel.

17. The non-transitory computer-readable medium of claim 16, wherein the light source and the sensor are located on a back plate of the display device.

18. The non-transitory computer-readable medium of claim 15, further comprising:
adjusting the predetermined range based on the cumulative time period of use of the display device, wherein a brightness used for the predetermined range is decreased as the cumulative time period increases.

19. The non-transitory computer-readable medium of claim 15, further comprising:
detecting that a temperature of the display device exceeds a thermal threshold; and
determining not to adjust the brightness of the display device to be brighter than a current brightness of the display device.

20. The non-transitory computer-readable medium of claim 15, further comprising:
transmitting the display status value over a network; and
updating the predetermined range based on data received over the network.
